(19) United States
(12) Patent Application Publication
(10) Pub. No.: US 2009/0140886 A1
(43) Pub. Date: Jun. 4, 2009

(54) MULTIPLE GEOFENCE SYSTEM FOR VEHICLES

(75) Inventor: Burnell L. Bender, Woodburn, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 11/949,079

(22) Filed: Dec. 3, 2007

(51) Int. Cl. G08G 1/123

(52) U.S. Cl. 340/988

(57) ABSTRACT

At least first and second geofences are established. The first geofence provides for indicating to an operator of a vehicle a limit to the territorial extent of a permitted operational area for the vehicle. The second geofence limits the territorial extent of a permitted operational area for the mobile platform, typically by limiting the mobility of the mobile platform. The first and second geofences are located with respect to one another and the permitted operational area so that with movement through the limits of the permitted operational area, the mobile platform encounters the first geofence no later than it encounters the second geofence.

### BACKGROUND OF THE INVENTION

1. Technical Field

The invention relates to geofencing for vehicles, and more particularly, to providing multiple geofences to allow nested, virtual regions and staggered responses to geofence violations.

2. Description of the Problem

A geofence may be defined in part as a virtual spatial boundary. Geofences are a byproduct of the marriage of mobile, inexpensive telecommunications platforms and data processing systems. While not dependent upon global positioning systems in theory, their accuracy is greatly enhanced by making use of global positioning systems to provide accurate and precise determination of the location of the mobile platform. A geofence is manifested in programmed responses of a data processing system installed on the mobile platform responsive to changes in the platform's position. Typically the positions which produce a given set of responses define a contiguous region. The edges of the region become a virtual boundary or geofence. The spatial location of a geofence, that is the limits of region, have commonly been established by selecting a point feature, which may be a point defined by latitude and longitude, and then defining either a radius, or lengths for the major and minor axes through the point, to establish a boundary around the point.

United States Pat. Appl. Pub. 2005/0159883 described a method and system relating to geofences which described various irregularly shaped geofences and distinguished between what it termed a geofence object and a geofence area (See generally paragraphs [0067-9] of the reference). The geofence object is described as enclosed by a geofence, and the geofence area encloses, in addition to the geofence object, a “hysteresis buffer area” outside and surrounding the geofence object. Responses to movement across the fence appear to require clearing the hysteresis area. Conceptually the publication seems to provide that the geofence has depth.

### SUMMARY OF THE INVENTION

According to the invention there is provided a system and method for controlling geofences for a mobile platform. At least first and second geofences are established. The first geofence provides for indicating to an operator of the mobile platform a limit in territorial extent of a permitted operational area for the mobile platform. The second geofence limits the territorial extent of a permitted operational area for the mobile platform, typically by limiting the mobility of the mobile platform. The first and second geofences are located with respect to one another and the permitted operational area so that with movement through the limits of the permitted operational area, the mobile platform encounters the first geofence no later than it encounters the second geofence. Usually the first geofence will circumscribe the territorial extent of the permitted operational area. Sometimes the permitted operational area surrounds the first and second geofences with the area within the second geofence being nested within the first geofence.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a map of a geographic region on which a geofence may be raised.

FIG. 2 is a graphical illustration of an irregular region which is both itself a set of nested regions defined by geofences and which includes nested, geofenced regions.

FIG. 3 is a block diagram schematic of a control system for a mobile platform which enables implementation of the staggered or tiered geofences of the present invention.

FIG. 4 is a flow chart of an algorithm for establishing nested geofences.

### DETAILED DESCRIPTION OF THE INVENTION

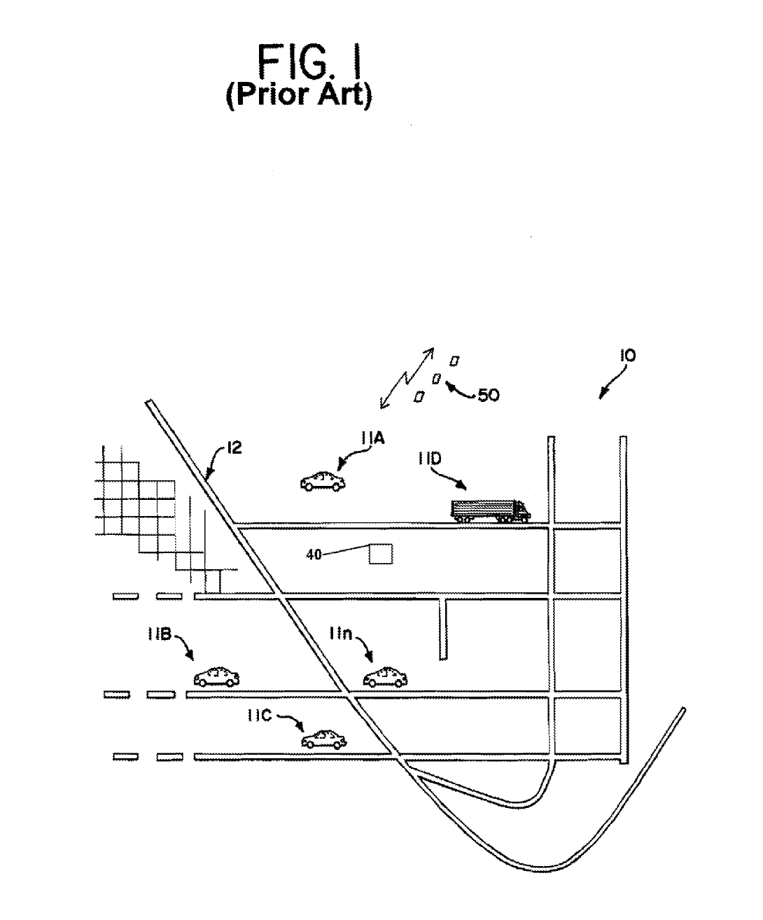

Referring now to FIG. 1, vehicles 11(A), 11(B), 11(C) . . . 11(n) travel on the road network 12 in the region 10. The vehicles 11 may include cars or trucks. Some or all of the vehicles 11 include suitable equipment that enables them to receive the global positioning information broadcast by a global positioning satellite constellation 50 and thus are mobile platforms with respect to which a geofence may be raised. Geofences (not shown) may be erected on region 10 through interaction of data processing equipment on board the vehicles with positioning data, or by response of a central control facility 40 to which the positioning data is reported. Each vehicle may be programmed with individual sets of responses so that the geofences applied to each vehicle are unique to that vehicle both as to location and as to the character of the responses.

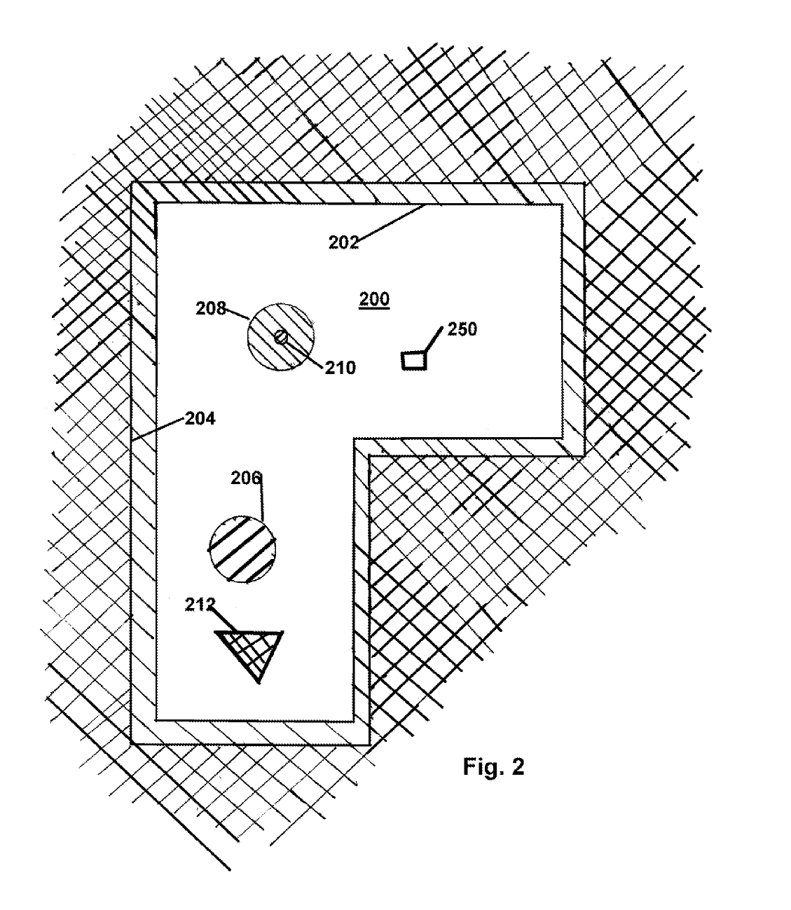

Referring to FIG. 2, a geofence may be based on an irregular polygon, a circle, a regular rectangle, or a combination of these shapes. In the present invention the responses which occur upon crossing a virtual boundary are “tiered” or “staggered”, to produce the effect of multiple boundaries, and to allow the nesting of regions. The mobile platform may be enclosed by a geofence (or geofences) or it may be limited to an area outside a zone defined by one or more geofences. Staggered responses are implemented by the use of nested geofences and directed to achieving any number of objectives. It may be considered desirable by an operator to prevent operation of commercial vehicles outside of a zone, but to warn drivers of the vehicles when they are approaching limits of the permitted operational area. Hence a first geofence may be used to produce a warning and a second geofence may be used to disable the vehicle. In other circumstances an operator may wish to make a zone a “no-stop” zone, but to permit transit through the area. Staggered responses may or may not be used depending upon the context.

In FIG. 2 a variety of regions have been defined by geofences including region or operational area 200 in which operation of a vehicle (not shown) is not inhibited. While the permitted operational area is shown as one contiguous region, it might comprise two or more non-contiguous regions connected by zones which permit transit but not stopping. Considering first a basic outer limit to vehicle operations, geofences 202 and 204 define limits on operation of a mobile platform 250. Upon crossing geofence 202 the driver of the vehicle is warned that the vehicle is approaching its permitted operational limit and at geofence 204 the programmed responses which define that limit come into play. These may include shutting down the vehicle, or imposing an extremely low speed limit on the vehicle. There is no reason why areas which are operationally restricted cannot be nested within a permitted region such as region 200. Such a situation is illustrated by geofences 208, 210, where a warning is issued upon crossing geofence 208 from region 200 toward geofence 210 and the vehicle is operationally restricted upon passing into the area defined within geofence 210. It is also possible to provide a operationally fully restricted zone such as enclosed by geofence 212, or an operationally partially restricted zone such as enclosed within geofence 206, either with or without warning zones. A partially restricted zone may allow vehicle operations through the zone without prolonged stops. A zone such as zone 206 could be used to link otherwise non-contiguous operational areas. It is conceptually possible for two geofences to merge for a portion of their lengths, but they are not permitted to cross so that first tier responses would occur after second tier responses as a vehicle left the non-inhibited, operational area 200.

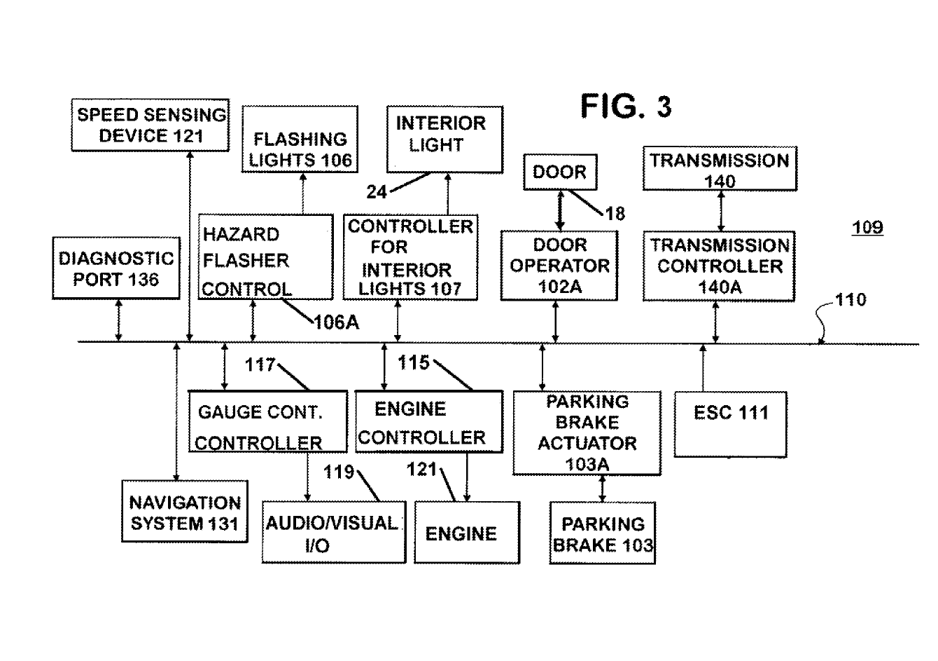

Referring particularly to FIG. 3, a block diagram schematic of a control system 109 for a vehicle illustrates systems used to implement the invention at an operational, physical level. Control system 109 includes an electrical system controller (ESC) 111, or equivalent, which may be taken to serve as a supervisory controller over the control system. Control system 109 further includes a plurality of relatively autonomous controllers or operators may include local data processing and programming and are typically supplied by the manufacturer of the controlled component. These controllers include the transmission controller 140A, the engine controller 115 and the gauge controller 117. There may also be generic, programmable controllers, these are particularly used to carry out operator defined tasks though they are not limited to such functions. The assignee of the present application markets generic controllers for controller area network applications, termed Remote Power Modules, which can be readily programmed from an external diagnostic port 136 or by the electrical system controller 111 in response to particular hardware attached to the remote power module. Possible examples of such controllers in control system 109 are the door operator controller 102A for door 18, a parking brake actuator 103A for the parking brake 103 and the lighting controllers 106A, 107 for the flashers 106 and interior lights 24.

The common data bus 110 is typically a serial data link 110 constructed as a twisted pair cable. It is typically externally accessible via a diagnostic port 136. Although the autonomous controllers handle many functions locally and may be capable of functioning without reference to ESC 111, they exchange data with ESC 111 and can receive operational direction from ESC 111 over the data bus 110. Bus 110 typically operates in accord with a protocol such as the Society of Automotive Engineers (SAE) J1939 protocol relating to controller area networks (CAN).

In an SAE 1939 compliant CAN, data buses may be private or public. A system topology will generally provide that the generic controllers are connected to a private bus and the dedicated controllers are connected to a distinct public bus. The ESC 111 is then connected to both buses and acts as a bridge between the buses. The general principal here is that generic controllers are typically used to provide customer specific functions, and use an customized communication set, which is not understandable by the dedicated controllers. This requires the ESC 111 to handle translation between the buses where a controller on one bus is required to respond to events being reported on the other bus and to allow data exchange between dedicated and generic controllers. The details of such a system are not relevant to the present invention and data bus 110 may be taken to be a conflation of public and private buses.

Typically any function which can be carried out by a generic controller may also be carried out by the electrical system controller (ESC) 111, provided output ports are available for connection of operational hardware to the ESC. The functions of the hazard light 106 flasher controller 106A, the controller 107 for the interior lights 24, or a controller actuator 103A for the parking brake 103 may be implemented as programming on ESC 111, or as programmed generic controllers which ESC 111 communicates with over bus 110.

A geofence is manifested as preprogrammed responses of the vehicle control system occurring with changes in vehicle position which alter vehicle operation in a way not conforming to normal operation. However, a geofence does not mandate any specific response and accordingly a geofence, in the sense of the invention, may be manifested as selected subsets of possible vehicle responses. In the preferred embodiment of the invention there are two tiers of responses, the first a warning issued to the driver and the second some limit on vehicle operation. Implementing limits on vehicle operation necessary involves vehicle operational variables and system controllers. For example, violation of the limits on the operational area for a vehicle may be manifested by limiting vehicle speed. A vehicle will have a sensed parameter measurement device such as a speed sensing device 121, which provides a signal indicating the vehicle's speed. A navigation system 131 provides the geographic location of the vehicle 10. The navigation system is conventionally supplied by a Global Positioning System (GPS) device that takes an external input from a satellite such as the commercially available LORAN system. The navigation system 131 may alternatively be a dead reckoning system without an external input or a combination of an external system and an internal to the vehicle dead reckoning system from the speed sensing device and other sensed parameter measurement devices. When the ESC 111 determines from the navigation system 131 that the vehicle is outside its permitted operational area it can limit engine 121 output to allow a maximum speed as reported by the speed sensing device. In the alternative, or in addition to these effects, the hazard flasher control 106A may be invoked for flasher 106 operation.

In the broader sense then, basic operations typically include providing for activation of geofence warning devices and operational inhibition for the vehicle in response to violation of geofences. The operating variable of vehicle position triggers all responses. The ESC 111 may be programmed to operate all, one, or some of the devices used for inhibiting the vehicle's operation or for warning an operator. Upon crossing a first tier geofence ESC 111 can cause gauge controller 117 to issue an audio warning over an audio/visual input/output device 119 on the vehicle dash panel. Upon the vehicle reaching the limits of its operational area the ESC 111 inhibits vehicle operation. It will be understood that the responses to violation of a geofence are flexible being limited only by reasonable prudence.

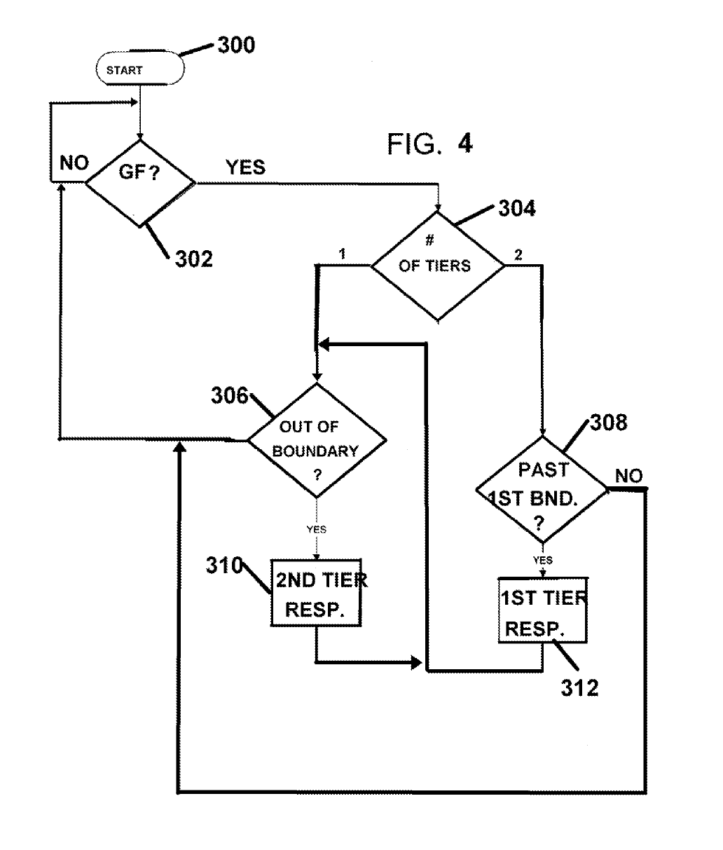

Referring to FIG. 4, a high level flow chart illustrates system operation. Beginning at step 300, program execution moves to determination as to whether geofences are active. If YES the program continues to determination as to whether one or two tiers of responses are provided (step 304). If one response tier is provided step 306 is executed to determine if the mobile platform (vehicle) has passed a geofence requiring full response to the incursion. If not program execution simply loops to step 302. If YES, first (if provided/applicable) and second tier responses are applied to the vehicle and maintained as long as the vehicle remains out of bounds (the program loops back to step 306).

If multiple tiers of responses to incursions into warning and prohibited zones are provided, than program execution following step 304 follows the “2” branch to step 308 where it is determined if the vehicle has passes a first tier geofence. If NO, than no response is required and the program loops to step 302. If YES, the first tier responses are executed and the program moves to step 306 to determine if the platform has violated a second tier geofence.

Those skilled in the art will now appreciate that alternative embodiments of the invention can exist. While the invention is shown in one of its forms, it is not thus limited but is susceptible to various changes and modifications without departing from the spirit and scope of the invention.

What is claimed is:

1. A method of controlling geofences for a mobile platform, the method comprising the steps of:
establishing at least a first geofence for indicating a limit in territorial extent of a permitted operational area for a mobile platform;
establishing a second geofence for limiting the territorial extent of a permitted operational area for the mobile platform; and
locating the first and second geofences relative to the permitted operational area so that with movement of the mobile platform through the limits of the permitted operational area from the permitted operational area, the mobile platform encounters the first geofence no later than it encounters the second geofence and the first and second geofences are not fully coincident.

2. A method in accordance with claim 1, wherein the permitted operational area surrounds the first and second geofences.

3. A method in accordance with claim 1, wherein the first geofence circumscribes the permitted operational area.

4. A method in accordance with claim 2, the method comprising the further steps of:
selecting differentiated sets of responses for the first and second geofences.

5. A method in accordance with claim 3, the method comprising the further steps of:
selecting differentiated sets of responses for the first and second geofences.

6. A geofence system comprising:
a vehicle;
a source of position information for the vehicle;
a vehicle control system including data processing facilities having access to the position information, the vehicle control system including facilities for issuing warnings to drivers and for inhibiting vehicle operation;
a program executable on the data processing facilities and responsive to the position information for causing the vehicle control system to issue warnings to a vehicle driver or to inhibit aspects of vehicle operation; and
the program providing first and second tiers of responses affecting vehicle operation relative to its normal operation, the first and second tiers of responses being selected from possible warnings and aspects of vehicle operation subject to inhibition, the first tier of responses occurring at some locations exclusive of the locations producing the second tier of responses.

7. A geofence system in accordance with claim 6, further comprising:
the locations corresponding to first tier responses and exclusive of the locations producing the second tier responses being contiguous and having a boundary defining a first geofence; and
the remaining locations corresponding to second tier responses being contiguous, spaced from the first geofence and separated from the locations of normal operation.

8. A geofence system in accordance with claim 7, further comprising:
the first geofence bounding the locations of normal operation.

9. A geofence system in accordance with claim 7, further comprising:
the first geofence being bounded by the locations of normal operation.
